(19) United States
(12) Patent Application Publication
(10) Pub. No.: US 2005/0103192 A1
(43) Pub. Date: May 19, 2005

(54) Reciprocating element

(76) Inventor: Jon D. Leyland, Gateshead (GB)

Correspondence Address: HARNESS, DICKEY & PIERCE, P.L.C., P.O. BOX 828, BLOOMFIELD HILLS, MI, 48303, US

(21) Appl. No.: 10/713,547

(22) Filed: Nov. 14, 2003

(51) Int. Cl. F16J 1/00

(52) U.S. Cl. 92/172

(57) ABSTRACT

A piston made of a dimensionally stable material and, on the outer peripheral side, is surrounded by a sealing ring that is capable of inflating outward and made of an elastically yielding material.

### FIELD OF THE INVENTION

The present invention relates to a piston made of a dimensionally stable material and a piston that is externally, on its outer periphery, enclosed by a sealing ring.

### BACKGROUND OF THE INVENTION

Pistons are generally known, for example, from DE 195 13 727 A1. In DE 195 12 727 A1, the piston can be moved back and forth parallel to its axis in a cylindrical housing, it contains a carrier part made of a hard material, and it contains a guide ring that externally, at least partially, encloses the carrier part. The guide ring consists of a polymeric material and is provided with sealing lips which, under an initial elastic tension, touch an inner wall of a housing that faces the piston. The carrier part and the guide ring are interlinked when pressed or locked together, and the carrier part is provided with at least one open groove that extends radially on the peripheral side in the direction of the guide ring. The groove is interlinked with at least one fabricated projection that protrudes radially in the direction of the carrier part. The guide ring has on both sides of the guide ring axially, fabricated one-piece sealing lips that extend in a radial direction over a contact surface of the carrier part. The pressing force, however, with which the sealing lips touch the surface of the housing where the sealing is to occur is relatively high, even when the pressure in the space to be sealed off is relatively low.

### SUMMARY OF THE INVENTION

An object of the of the invention is to provide a piston wherein a friction of the piston within the housing, particularly when a low pressure is to be contained, is reduced. Moreover, it is an object of the present invention to provide a piston that is fabricated in a simple and economic fashion that maintains good properties over a long service life.

To reach the above objectives, a piston made of a dimensionally stable material is surrounded, on its outer periphery, with a sealing ring that is made of an outward inflatable, elastically yielding material. By means of the inflatable sealing ring, the pressing force with which the sealing ring touches the surface of the piston-surrounding housing is adapted to the conditions of a desired application, and is varied to render a pressing force that is proportional to a pressure that is to be contained.

More particularly, at very low pressure, the sealing ring is only very slightly inflated or not inflated at all, and the surface of the piston-surrounding housing is touched with only a very low pressing force. As a result of this low pressing force exerted by the sealing lip against the sealing surface of the housing, the piston can be moved back and forth in the housing very sensitively. Moreover, this slight pressing force reliably prevents stick-slip effects.

For example, if the sealing pressure within the housing increases, the sealing ring is inflated further, and thus the sealing ring touches the housing surface with an increased pressing force at a point in which the sealing is to occur.

Further, the friction between the inflatable sealing ring and the sealing surface of the housing can be made proportional to the pressure to be contained.

The sealing ring is preferably made from a polymeric material and more preferably, from a PTFE compound [PTFE=polytetrafluoroethylene]. In this manner, the friction between the sealing ring and the sealing surface can be further reduced. Moreover, such a piston will consistently exhibit good properties during its very long service life because the sealing ring, after an initially negligible wear vitrifies. The piston, therefore, is highly resistant.

The piston is preferably provided with a jacket in the form of a hollow cylinder which, for purposes of inflating the sealing ring, is provided with at least one recess that connects a pressurizable working space with an internal peripheral surface of the sealing ring. The thus prevailing pressure in the working space also acts on the internal peripheral surface of the sealing ring. For example, if the pressure in the working space increases, the increased pressure acts on the inner surface of the sealing ring by inflating it radially outward in a direction of the sealing surface. As such, the sealing ring automatically seals by pressing against the sealing surface with a variable force.

On the other hand, if the pressure within the working space is reduced, the pressure applied to the internal peripheral surface of the sealing ring is also reduced. As such, a comparatively lower pressure is contained by a comparatively lower force that presses the sealing ring against the sealing surface.

The working space is limited by a housing that surrounds the piston on its outer peripheral side. The piston can be used, for example, as a shock absorber in automotive vehicles.

The inflatable region can be created, for example, by a convex bulge of the sealing ring that is directed outward radially when viewed along a longitudinal section of the piston, or by providing the sealing ring with at least one outwardly springy sealing lip in its inflatable region. In this manner, the sealing ring becomes capable of touching the sealing surface of the housing.

An advantage of the convex outward bulging region is that the piston will exhibit particularly good sealing properties when it is disposed slightly eccentrically, relative to the housing. Moreover, such a piston can be produced in a simple and economic fashion.

On the other hand, if the sealing ring is provided with a sealing lip that can elastically expand outward, a sealing effect against the housing is activated within the working space, even at low pressures.

In this case, the sealing lip has a hinged film, and is created by making a cut into the sealing lip material, without removing any material.

The automatic inflation of the sealing ring occurs exclusively as a function of pressure in the working space. As such, the ring does not require separate activation devices.

The medium for inflating the sealing ring can be hydraulic or pneumatic, depending on which medium is desired within the working space. Further, the inflatable region can be frontally located on one side of the sealing ring which is advantageous for many applications.

In the case that only the inflatable region of the sealing ring is pressed against the sealing surface of the housing, it is advantageous that, as a result of this spatially limited orientation, the friction between the sealing ring and the sealing surface of the housing be reduced to a minimum.

In another application, particularly when the piston is moved back and forth in an axial direction and when it is intended to seal in both directions, it is advantageous that the inflatable region be frontally located on one side of the sealing ring with a sealing lip being frontally provided on the other side. An example of such an application is when the piston is used as a shock absorber in a motor vehicle. In such a case, a sealing effect in one direction is accomplished by the inflatable region. Moreover, a sealing effect is accomplished in the other direction by the sealing lip. As stated above, this arrangement can be particularly advantageous for use as a shock absorber of motor vehicles because a reliable sealing effect is provided even under extreme conditions. For example, when a lateral force acts on the piston and/or the piston, because of reasons related to fabrication and/or assembly, is disposed eccentrically within the housing. During operation of the piston, the sealing lip is then effective in only one direction.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a first embodiment according to a principle of the present invention wherein, when pressure is applied, the sealing ring inflates radially in the direction of the sealing surface; and

FIG. 2 shows a second embodiment according to a principle of the present invention wherein the sealing ring encloses a sealing lip capable of elastically expanding in the direction of the sealing surface.

### DETAILED DESCRIPTION OF THE PREFERRED EMBODIMENTS

The following description of the preferred embodiment(s) is merely exemplary in nature and is in no way intended to limit the invention, its application, or uses.

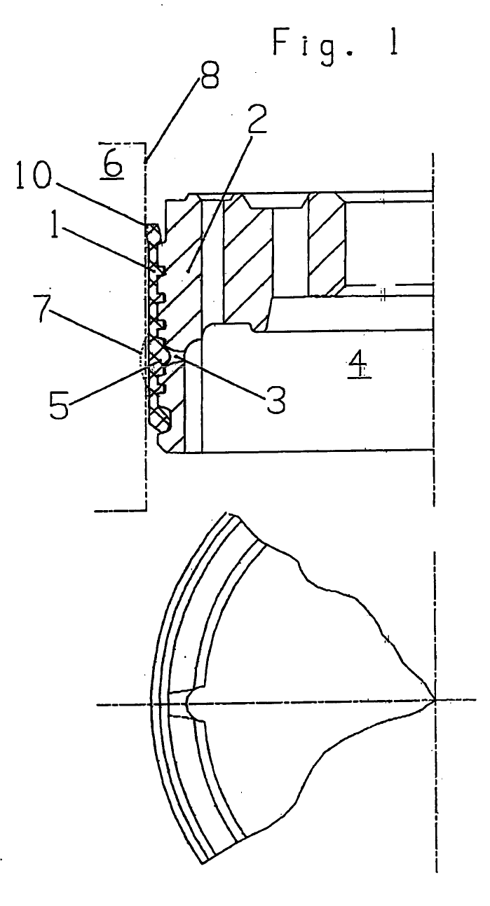

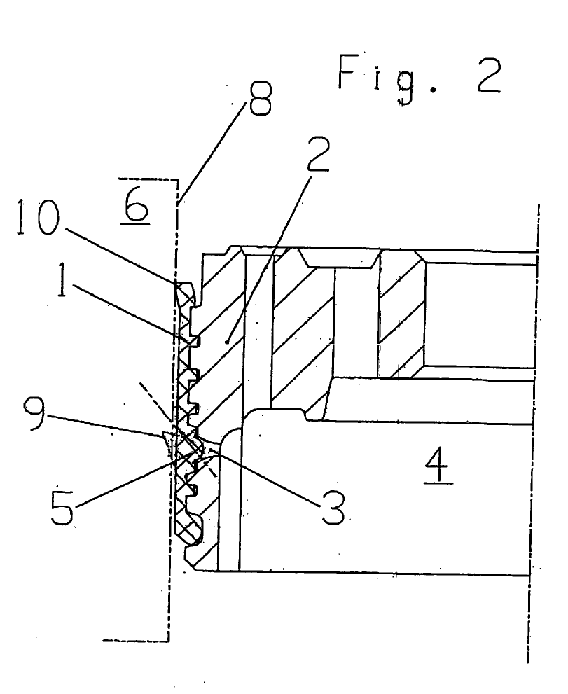

FIGS. 1 and 2 show pistons according to the principles of the present invention. As shown in FIG. 1, a sealing ring 1 of the piston of the invention is provided with an inflatable region 7 located frontally on one side. A sealing lip 10 is located frontally on the other side. The sealing ring 1 is designed as a bandage that encloses the piston, and has an axial extension that closely corresponds to an extension of the piston. On the sides facing each other, the piston and sealing ring 1 have congruent profiles that accomplish a force-actuated connection and/or interlocking of the parts. In a variation of this embodiment, the sealing lip 10 is absent (not shown), and only the inflatable region 7 of sealing ring 1 touches a sealing surface 8 of a housing 6 to bring about a sealing effect.

In a non-pressurized state, the sealing surface 8 of the housing 6, which is shown only schematically here, is disposed a small radial distance from sealing ring 1. Alternatively, the sealing ring 1 may touch the housing 6 with only a very slight preliminary radial tension. When low pressures are prevalent within a working space 4, the contact pressure of the sealing ring 1 against the sealing surface 8 is only minor. When an increased pressure is prevalent within working space 4, on the other hand, the pressure may propagate through a recess 3 disposed within a jacket 2 of the piston to an inner peripheral surface 5 of the sealing ring 1. The pressure inflates the inflatable region 7 of the sealing ring 1 in the direction of the sealing surface 8 of the housing 6 in a manner such that the inflatable region 7 then touches the sealing surface 8 at a higher preliminary radial tension.

When the pressure in the working space 4 is reduced, the inflation of the inflatable region 7 again decreases as a result of the elasticity of the material that constitutes sealing ring 1.

In FIGS. 1 and 2, the sealing ring 1 is represented by broken lines. The automatic inflation of sealing ring 1 occurs exclusively as a function of the pressure in working space 4.

Further, FIG. 1 depicts a first embodiment of the piston of the invention wherein sealing ring 1, viewed in the longitudinal direction of the piston, has a tubular shape and is linked to the surface of the piston. Upon increasing the pressure in the working space 4, the inflatable region 7 inflates outward in a convex, radial manner to thus touch the sealing surface 8 of the housing 6 in a sealing fashion.

FIG. 2 shows a second embodiment of the invention that differs from the embodiment of FIG. 1 in that the inflatable region 7 is formed by a sealing lip 9 which, when the pressure within the working space 4 increases, swings outward radially in the direction of sealing surface 8 of the housing 6 to thus touch the sealing surface 8 in a sealing manner. Preferably, the sealing lip 9 is in the form of a hinged film.

The description of the invention is merely exemplary in nature and, thus, variations that do not depart from the gist of the invention are intended to be within the scope of the invention. Such variations are not to be regarded as a departure from the spirit and scope of the invention.

1. A piston comprising:
a dimensionally stable material;
wherein said piston is enclosed at an outer periphery thereof by a sealing ring formed of an elastically yielding material; and
the sealing ring is capable of being inflated outward radially.

2. The piston according to claim 1, wherein the sealing ring comprises a polymeric material.

3. The piston according to claim 1, wherein the sealing ring comprises a PTFE compound.

4. The piston according to claim 1, further comprising:
a jacket formed of a hollow cylinder, wherein the jacket has at least one recess that links a pressurizable working space of the piston with an peripheral inner surface of the sealing ring, and said jacket enables an inflation of said sealing ring.

5. The piston according to claim 4, wherein the working space is limited by a housing that encloses the piston.

6. The piston according to claim 1, wherein an inflatable region of the sealing ring is provided with at least one sealing lip that is capable of elastically expanding outward and touching a sealing surface of the housing.

7. The piston according to claim 6, wherein the sealing lip comprises a hinged film.

8. The piston according to claim 1, wherein an automatic inflation of the sealing ring occurs exclusively as a function of a pressure in a working space disposed within said piston.

9. The piston according to claim 1, wherein the sealing ring comprises a hydraulic or pneumatic inflating medium.

10. The piston according to claim 1, wherein the sealing ring includes an inflatable region frontally located at one side of the sealing ring.

11. The piston according to claim 1, wherein the inflatable region of the sealing ring touches a sealing surface of a housing.

12. The piston according to of claim 1, wherein an inflatable region is frontally located on one side of the sealing ring; and
a sealing lip is frontally provided on another side of the sealing ring that faces axially away from said inflatable region.

13. A piston comprising:
a pressurizable working space;
a jacket formed of a hollow cylinder coupled to the pressurizable working space; and
an inflatable sealing ring coupled to and disposed at an outer surface of the jacket, the inflatable sealing ring sealing a region between the piston and a housing;
wherein the sealing ring is inflated by pressurizing the working space.

14. The piston according to claim 13, wherein the sealing ring comprises a convex bulb that inflates to seal the region between the piston and the housing.

15. The piston according to claim 13, wherein the sealing ring comprises a sealing lip formed of a hinged film that expands outward to seal the region between the piston and the housing.

16. The pistion according to claim 13, wherein the sealing ring inflates to an amount proportionate to a pressure contained with in the pressurizable working space.
